(19) United States
(12) Patent Application Publication
(10) Pub. No.: US 2025/0291627 A1
(43) Pub. Date: Sep. 18, 2025

(54) SYSTEMS AND METHODS FOR ASYNCHRONOUS MULTI-THREADED ROBOTIC PROCESS AUTOMATION

(71) Applicant: WELLS FARGO BANK, N.A., San Francisco, CA (US)

(72) Inventors: Dinesh Kumar Sabat, Tega Cay, SC (US); Rajagopal Malakapalli, Marvin, NC (US); Thiruchenthil Subramaniam, Concord, NC (US); Eduardo DeLa Torre, Oakland, CA (US); Dennis E. Montenegro, Concord, CA (US); Sadie S. Salim, Mill Valley, CA (US)

(21) Appl. No.: 18/603,981

(22) Filed: Mar. 13, 2024

(51) Int. Cl. G06F 9/48

(52) U.S. Cl. CPC G06F 9/4881

(57) ABSTRACT

Systems and methods of robotic process automation including: receiving a multi-threaded task request from a messaging application; automatically dividing the multi-threaded task request into a plurality of subtasks based on metadata associated with the multi-threaded task requests; generating a queue comprising one or more subtasks from the plurality of subtasks; identifying an application programming interface associated with the one or more subtasks from the queue; routing the one or more subtasks to the application programming interface; receiving a response from the application programming interface associated with executing the one or more subtasks; and providing the response to the messaging application.

### FIELD OF INVENTION

The present disclosure generally relates to robotic process automation, and more particularly to systems and methods for using asynchronous multi-threading in robotic process automation to provide improved scalable multi-tasking capabilities of computer systems during process automations.

### BACKGROUND

Enterprises often implement automated systems to improve worker efficiency in performing various tasks. The field of process automation provides solutions in improving worker efficiency by distilling worker tasks into scripts executable by the worker's computer, which are then performed by the worker's computer. Current process automation methods are flawed however because they require users to make sacrifices between the availability of local computer resources when executing the scripts on a local computer, and accuracy when executing the scripts through a cloud service by relying on potentially outdated data. Current process automation methods do not use multi-threaded task requests and messaging systems to perform parts of tasks asynchronously, concurrently, or with up-to-date information.

### SUMMARY

In an aspect, an example method includes: receiving a multi-threaded task request from a messaging application; automatically dividing the multi-threaded task request into a plurality of subtasks based on metadata associated with the multi-threaded task requests; generating a queue comprising one or more subtasks from the plurality of subtasks; identifying an application programming interface associated with the one or more subtasks from the queue; routing the one or more subtasks to the application programming interface; receiving a response from the application programming interface associated with executing the one or more subtasks; and providing the response to the messaging application.

In a further aspect, further example methods include converting the multi-threaded task request into JavaScript Object Notation (JSON) text format. In other examples, the method may further include polling the messaging application for an additional multi-threaded task request.

In another aspect, the plurality of subtasks may include one or more of: gathering user data, editing forms with the user data, generating a document, verifying identity of a user, creating user data, generating a profile based on the user data, updating user data, and deleting user data. In further examples, the response includes information associated with an error in execution of one or more subtasks and the method includes receiving a request from the messaging application to execute a failed subtask.

In an aspect, an example system for performing robotic process automation includes: a first bot configured to receive a multi-threaded task request from a messaging application, automatically divide the multi-threaded task requests into a plurality of subtasks based on metadata associated with the multi-threaded task requests, and loading the one or more subtasks in a queue; and a second bot configured to identify an application programming interface associated with the one or more subtasks in the queue, rout the one or more subtasks to the application programming interface, receive a response from the application programming interface associated with executing of the one or more subtasks associated, and provide the response to the messaging application.

In another aspect, an example system may include a data format conversion module for converting the multi-threaded task request to a JavaScript Object Notation (JSON) text format. In a further example, the first bot polls the messaging application for an additional multi-threaded task request. In another example, the plurality of subtasks may include one or more of: gathering user data, editing forms with the user data, generating a document, verifying identity of a user, creating user data, generating a profile based on the user data, updating user data, and deleting user data.

In an additional aspect, the response from the application programming interface includes information associated with an error in execution of one or more subtasks and the first bot is further configured to receive a request from the messaging application to execute a failed subtask.

In a further aspect, an example system includes a node configured to receive a user selection, generate the multi-threaded task request based on the user selection, and transmit the multi-threaded task request to the messaging application. In another aspect, the messaging application provides the multi-threaded task request to the first bot receives the multi-threaded task request from the messaging application using a publish-subscribe model of communication.

The above methods can be implemented as computer-executable program instructions stored in a non-transitory, tangible computer-readable medium or media and/or operating within a processor or other processing device and memory.

### BRIEF DESCRIPTION

A full and enabling disclosure is set forth more particularly in the remainder of the specification. The specification makes reference to the following appended figures.

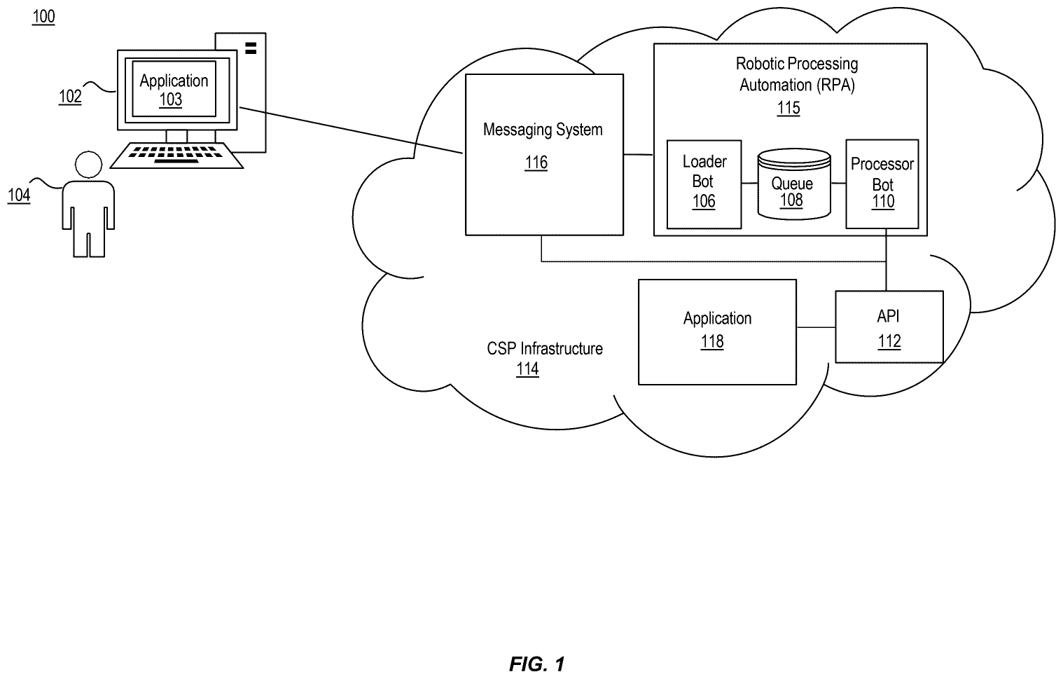

FIG. 1 illustrates an example system for robotic processing automation.

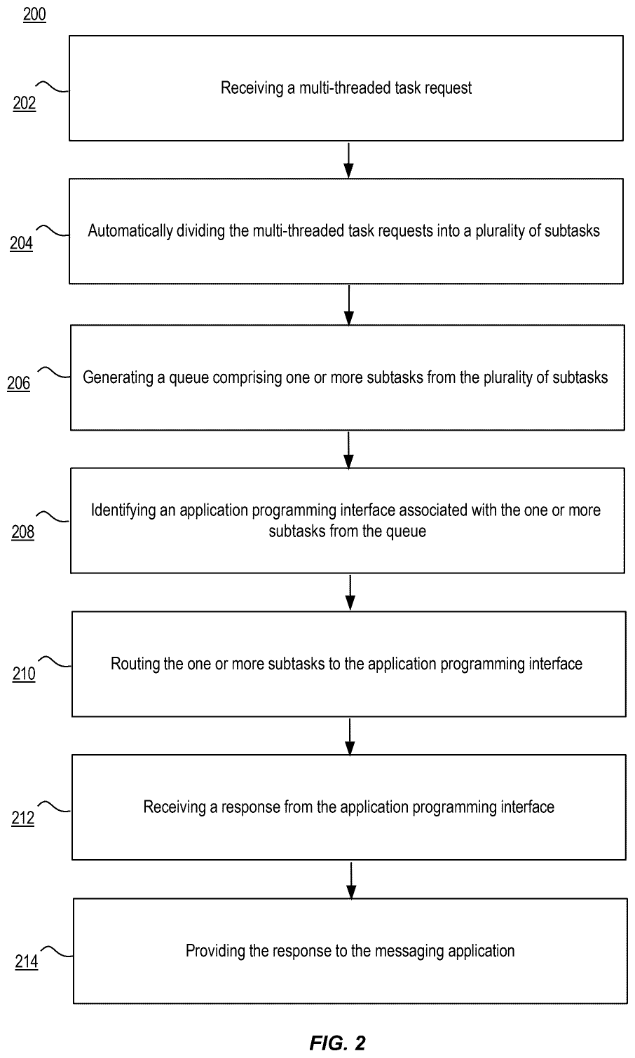

FIG. 2 illustrates a flow chart for a method of robotic processing automation.

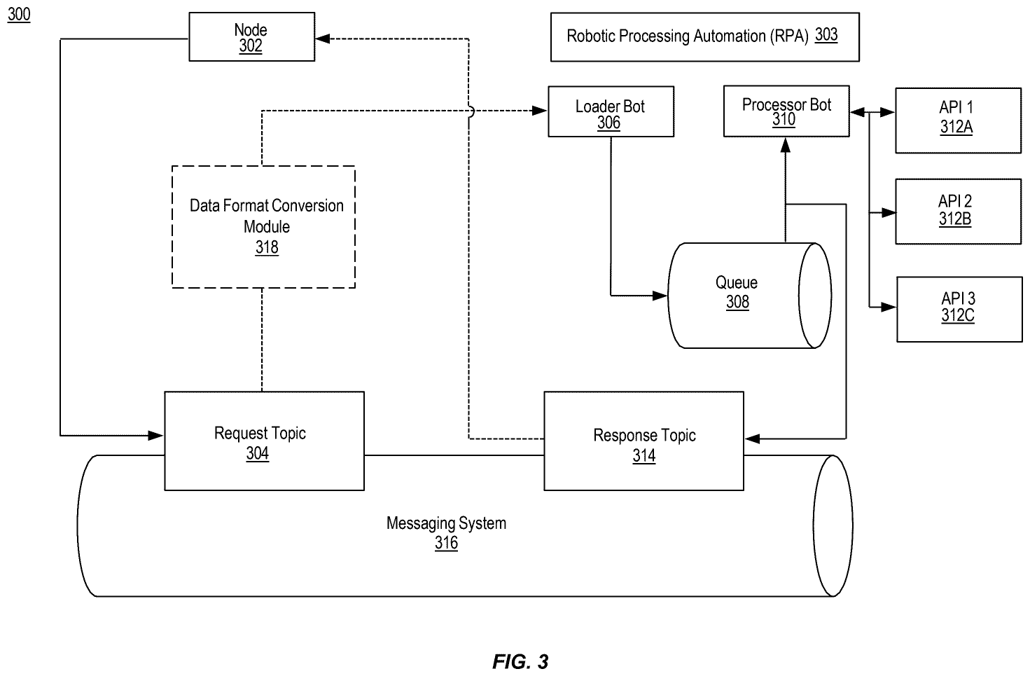

FIG. 3 illustrates an example of system architecture for robotic processing automation.

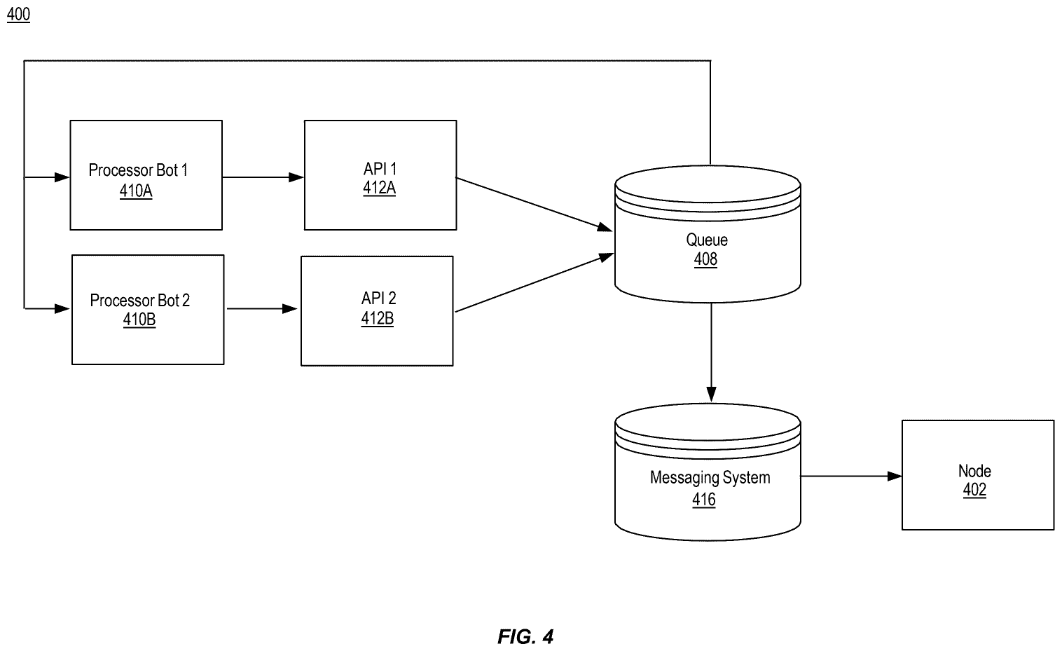

FIG. 4 illustrates an example of providing responses to a target node.

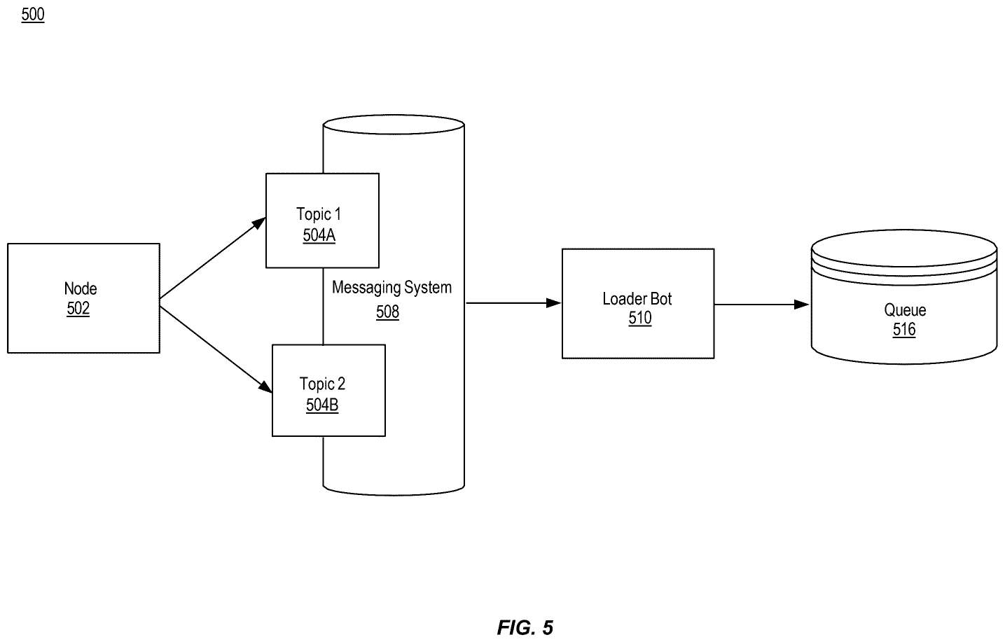

FIG. 5 illustrates an example of loading a queue of subtasks.

### DETAILED DESCRIPTION

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

### Illustrative Embodiment of a System for Robotic Processing Automation

In one illustrative embodiment, a system for robotic processing automation includes an application for generating multi-threaded task requests from user selections of tasks. Users may access the application through a browser or application executed locally on a user device, such as a personal computer or smartphone. Users select tasks through a user interface and based on the users' selections, the application generates the multi-threaded task request.

Multi-threaded task requests are messages that include information for a robotic processing automation module to perform the user selected task. Multi-threaded task requests may include a set of individual subtasks, which when executed, perform the multi-threaded task request.

The application provides the multi-threaded task request to a messaging system, such as Apache Kafka or Apache Avro. The messaging system posts the multi-threaded task request to a topic on the messaging system, and the robotic processing automation (RPA) module polls the topic to identify posted multi-threaded tasks. Topics include partitioned data spaces to store multi-threaded task requests and subtasks, such as a folder or other data structure.

The RPA module may include multiple bots, such as one or more loader bots and one or more processor bots. Bots are software programs configured to automate actions for the user. The loader bot receives multi-threaded task requests from the messaging system and divides the multi-threaded task request into various subtasks. In some examples, the loader bot divides the multi-threaded task based on metadata associated with the multi-threaded task request. In further examples, the multi-threaded task request includes instructions for dividing the request into subtasks. In even further examples, the application generating the multi-threaded task request divides the request into individual subtasks and provides the individual subtasks to the messaging system. In such an example, the loader bot may receive subtasks from the messaging system.

The loader bot generates a queue (e.g., a data array) of subtasks and loads the queue with the subtasks. In some examples, the queue is a prebuilt storage platform, such as a UiPath queue. Processor bots pull subtasks from the queue, identify an application programming interface (API) associated with the one or more subtasks from the queue, and rout the subtasks to the application programming interface.

Applications associated with the application programming interfaces perform the subtasks and provide a response to the processor bot or messaging system. The response may include information associated with the performance of a subtask, or the results of performing the subtask. For example, when a subtask is to generate a PDF document including user information, the response may include the generated PDF document, information indicating that the subtask was successfully completed, and information indicating what user information is included in the PDF document.

The response may further indicate whether the application performing the subtask successfully performed the subtask, was unsuccessful in performing the subtask, or was only partially successful in performing a subtask. For example, when the application fails to generate a PDF document, the response may include an error message indicating the subtask was not performed or that only the first page of the PDF document was generated.

The messaging system may receive the response from the processor bot or from the application performing the subtask. The messaging system stores the response to a topic associated with the multi-threaded task request, or a topic associated with completed subtasks. The application that generated the multi-threaded task request may periodically poll the topic associated with the multi-threaded task request and provide the user with the response when the messaging system indicates performance of the subtasks.

Based on the response, the application provides the user with results from performing the multi-threaded task request, such as generated documents or a confirmation receipt. In examples where individual subtasks from a multi-threaded task request were not performed successfully, the application may generate an additional multi-threaded task request including failed subtasks to reattempt to perform remaining subtasks from the failed multi-threaded task request.

### Illustrative Example for a System for Robotic Processing Automation

In one illustrative example, the application receiving user selections of tasks may be a banking application. The user may select banking products, such as a mortgage, through a user interface of the application. Based on the user selection, the banking application generates a multi-threaded task request for performing the selected task. For example, when a user selects to apply for a mortgage, the banking application may generate a multi-threaded task request associated with applying for a mortgage. In one such example, the multi-threaded task request may include various subtasks for applying for a mortgage loan, such as: (1) confirming the user's identity; (2) generating a user profile for the user; (3) checking the user's credit score; (4) generating PDF documents of the mortgage loan; and (5) editing forms for the mortgage application with user data. The banking application may generate multi-threaded task requests based on enterprise rules associated with the user selections. For example, a multi-threaded task request for opening a savings account may include different subtasks from applying for a mortgage loan. In further examples, the multi-threaded task request may include a subtask requesting an application create user data, such as a value associated with the user's credit or assets. For example, when a user applies for a mortgage, a subtask may include a request to an application to freeze the user's credit and identify user assets until the application is processed so that the mortgage rates and limits are accurate based on the user's credit or identified assets. The enterprise operating the system for robotic processing automation may control which subtasks comprise a multi-threaded task request based on enterprise rules.

The banking application provides the multi-threaded task request to a messaging system. In some examples, the banking application may post the multi-threaded task request to a topic of the messaging system. A robotic processing automation module may poll the topic of the messaging system for posted multi-threaded task requests and pull the multi-threaded task request from the topic. In other examples, the messaging system may use a publish-subscribe model of communication with the robotic processing automation module to transmit the multi-threaded task request to a topic of the messaging system. The messaging system automatically notifies loader bots subscribed to the topic of added multi-threaded task requests. In some examples, the messaging system may stream multi-threaded task requests to the loader bots or RPA module. In further examples, the messaging system may be part of the application executed on the user device and may provide multi-threaded task requests to the robotic processing automation module, such as by polling topics of the messaging system, through a publish-subscribe model, or by streaming multi-threaded task requests.

A loader bot of the robotic processing automation module may divide the multi-threaded task request into a plurality of subtasks based on metadata of the multi-threaded task request. The loader bot stores the plurality of subtasks to a queue, such as UiPath queue.

A processor bot pulls subtasks from the queue and identifies an application programming interface associated with the subtasks. For example, the subtask may include generating PDF documents for a mortgage loan. The processor bot provides the subtask to an application programming interface associated with an application for generating PDF documents. An example snippet of code indicating the structure of a subtask is provided below:
{“messagetype”: “afiFormFillingRequest”,
   “rpaRequestId”: “123456”,
   “bricRequestId”: 12345678,
   “requestDateTime”: “2024-01-12T14:19:00.0000Z”,
   “payload”: {
      “bankerName”: “John”,
      “officerCode”: “J123”,
         “bankerAU”: “02020”,
         “bankerMac”: “123”,
         “businessECN”: “9876543212345”,
         “ownerIndividualDetails”:
         [{
         “ecn”: “1234”,
         “position Title”: “Owner”
}]}}

The application performing the subtask may return a response to the processor bot regarding the performance of the task. For example, the response may include a confirmation receipt that the subtask was performed. In further examples, the response may include results from performing the subtask.

An example snippet of code indicating the structure of a sample response is provided below:
@Data
public class FillFormsResponsePayload {
   private String formDraftLocation;
   private String formFillingStatus;
   private String exceptionFields;
   private String errorMessage;
}

The banking application receives the response, and based on the response, provides results of executing the multi-threaded task request and generates additional multi-threaded task requests. For example, the banking application may receive a response indicating that one or more subtasks from the multi-threaded task request was not executed. The banking application may generate an additional multi-threaded task request including subtasks that were not executed and provide the additional multi-threaded task request to the messaging system.

In some examples, the loader bot or the processor bot may identify based on the response from the application performing the subtask and determine to provide failed subtasks to the application or another application to execute the subtask. In some examples, the loader bot or processor bot may be programmed to follow enterprise rules regarding how many attempts to make to resend failed subtasks to the same application, when to report an unresolved error in processing a subtask, and when to provide a failed subtask to a different application.

### System for Robotic Processing Automation

FIG. 1 illustrates a system 100 for robotic processing automation. The system 100 includes an application 103 executed on a user device 102. The system further includes a messaging system 116, a robotic processing automation (RPA) module 115, which includes a loader bot 106, a queue 108, and a processor bot 110. The processor bot 110 transmits subtasks to application programming interface (API) 112 which provides the subtask to an application 118 to perform the subtask. The messaging system 116, application programming interface (API) 112, application 118, and robotic processing automation (RPA) module 115 including the loader bot 106, queue 108, and processor bot 110 operate on cloud service provider infrastructure 114. In some examples, the messaging system 116, robotic processing automation (RPA) module, application programming interface (API) 112, and application 118 operate on different cloud service provider infrastructure.

A user 104 interacts with a user interface of the application 103 to select tasks. The application 103 generates a multi-threaded task request based on the user's selection and provides the multi-threaded task request to a messaging system 116.

The messaging system 116 stores the multi-threaded task request and provides the multi-threaded task request to the loader bot 106 of the robotic processing automation (RPA) module 115.

The loader bot 106 receives the multi-threaded task request and divides the multi-threaded task request into a plurality of subtasks. In some examples, the loader bot 106 divides the multi-threaded task request based on metadata of the request. In further examples, the multi-threaded task request includes instructions for the loader bot 106 for dividing the multi-threaded task request.

The loader bot 106 provides the subtasks to the queue 108. The queue 108 may be a data array of subtasks. In some examples, the loader bot 106 generates a queue 108 for individual multi-threaded task requests. For example, the loader bot 106 may generate a first queue for a first multi-threaded task request and a second queue for a second multi-threaded task request.

The processor bot 110 pulls subtasks from the queue 108. In some examples, there are multiple processor bots. The processor bot 110 identifies an application to execute a subtask and provides the subtask to an application programming interface (API) 112 associated the subtask. For example, the subtask may be to run a credit report on a user. The processor bot 110 may provide the subtask to an application programming interface (API) 112 associated with a credit reporting application.

The application 118 executes the subtask and generates a response based on the execution of the subtask. The response may include a confirmation receipt that the subtask was executed. In some examples, the response may include an error code to indicate that the subtask was not executed. The application programming interface provides the response to the processor bot 110, which provides the response to the messaging system 116. In some examples, the application programming interface (API) 112 provides the response directly to the messaging system 116.

The application 103 receives the response from the messaging system 116 and provides the response to the user 104. In some examples, the application 103 may generate an additional multi-threaded task request based on subtasks the response indicates were not executed by application 118.

### Illustrative Method for Robotic Processing Automation

FIG. 2 is a flowchart showing illustrative method 200 for operating a system for robotic processing automation. In some examples, some of the steps in the flow chart of FIG. 2 are implemented in program code executed by a processor, for example, the processor in a general-purpose computer, mobile device, or server. In some examples, these steps are implemented by a group of processors. In further examples the steps shown in FIG. 2 are performed in a different order or one or more steps may be skipped. Alternatively, in some examples, additional steps not shown in FIG. 2 may be performed.

At block 202, the method 200 includes receiving a multi-threaded task request. A user may input a selection of service to an application. Based on the user's selection, an application generates a multi-threaded task request associated with the selection. Multi-threaded task requests are messages that includes instructions for a robotic processing automation module to perform a task. As further described in the description of FIG. 1, a loader bot, may receive the multi-threaded task request from a messaging system.

In some examples, the loader bot may receive the multi-threaded task request from a messaging system using a publish-subscribe model of communication. The application may publish the multi-threaded task request to a topic of the messaging system. Loader bots may subscribe to topics from the messaging system. When multi-threaded task requests are published to a topic, the messaging system may transmit the multi-threaded task requests to subscribed loader bots.

In other examples, the loader bot may periodically poll the messaging system to identify whether the messaging system received multi-threaded task requests.

At block 204, the method 200 includes automatically dividing the multi-threaded task requests into a plurality of subtasks. The loader bot may divide the multi-threaded task requests based on metadata associated with the multi-threaded task requests. In further examples, the multi-threaded task requests include instructions for dividing the multi-threaded task request into a plurality of subtasks.

At block 206, the method 200 includes generating a queue comprising one or more subtasks from the plurality of subtasks. The loader bot may generate a queue by storing the subtasks in cloud memory storage of the cloud infrastructure operating the robotic processing automation module.

In some examples, the loader bot may generate a plurality of queues. The loader bot may generate queues for individual processor bots. For example, the loader bot may store subtasks from a multi-threaded task request into different queues based on similarities between subtasks. For example, the loader bot may store subtasks associated with generating documents in a first queue and subtasks associated with authenticating user identity in a second queue.

At block 208, the method 200 includes identifying an application programming interface (API) associated with the one or more subtasks from the queue. Processor bots from the robotic processing automation module may pull subtasks from the queue and identify an application programming interface of an application to execute the subtask.

At block 210, the method 200 includes routing the one or more subtasks to the application programming interface. The processor bot routes subtasks to an application programming interface associated with the subtasks. For example, when a subtask is associated with generating a credit report, the processor bot may route the subtask to an application programming interface of a credit reporting application.

At block 212, the method 200 includes receiving a response from the application programming interface. The response may include information associated with the performance of the subtask. For example, when the subtask includes generating documents, the response may include generated documents, or a confirmation receipt associated with the performance of the subtask. In some examples, the response may include an error code indicating that a subtask was not performed.

At block 214, the method 200 includes providing the response to the messaging application. The processor bot may provide the response to the messaging application. For example, the processor bot may provide the response to a topic associated with a multi-threaded task request. The application that generated the multi-threaded task request may periodically poll the topic of the messaging system and when the response is saved to a topic, the application may pull the response.

### Illustrative System Architecture for Robotic Processing Automation

FIG. 3 illustrates example system architecture 300 for robotic processing automation. The system architecture 300 includes a node 302; a messaging system 316 including a request topic 304 and response topic 314; a robotic processing automation (RPA) module 303 including a loader bot 306, a queue 308, and processor bot 310; and APIs 312A, 312B, 312C.

The node 302 may include a computer application executed on a user device such as a smartphone, computer, and laptop. Users interact with the node to select a task to perform. The node 302 generates a multi-threaded task request associated with a user selected task. In further examples, the system architecture 300 may include multiple nodes.

The node provides the multi-threaded task request to request topic 304 of the messaging system 316. Request topic 304 may include a location in memory of the messaging system 316 where the node 302 stores the multi-threaded task request. The messaging system 316 may have a separate request topic for different nodes or different multi-threaded task request.

In some examples, the system architecture 300 includes a data format conversion module. The data format conversion module 318 may comprise computer code for converting multi-threaded task requests into a format readable by the loader bot 306, such as a JavaScript Object Notation (JSON) text format.

The loader bot 306 may receive multi-threaded task requests from request topic 304. The loader bot 306 divides the multi-threaded task request into subtasks based on metadata or instructions associated with the multi-threaded task requests and stores the subtasks to queue 308.

Queue 308 is a data array of subtasks stored by the loader bot 306. In some examples, the loader bot 106 generates the queue 308 for individual multi-threaded task requests in memory. In further examples, the queue 308 may be a storage platform provided by another entity, such as UIPath queue.

Processor bot 310 pulls subtasks from queue 308 and identifies an application programming interface 312A 312B 312C to provide the subtask. In some examples, the processor bot identifies the application programming interface 312A 312B 312C by matching the subtask to actions performable by an application associated with the application programming interface 312A 312B 312C. In some examples, the subtask may include information associated with the subtask. For example, the subtask may be to authenticate a user's identity. The subtask may include personal information such as a user's name, address, phone number, social security number, username, and password. The processor bot 310 may match the subtask to an application programming interface associated with an authentication application, such as application programming interface 1 312A.

In some examples, the processor bot 310 may match the subtask to an application programming interface based on the information included with subtask. For example, when the subtask includes personal information such as medical history, the processor bot 310 may match the subtask to application programming interface associated with an authentication application complying with data privacy protections for handling medical history.

The application programming interfaces 312A 312B 312C provide the subtask to an associated application. The application executes the subtask and returns a response to the processor bot 310 indicating whether the subtask was successfully executed. In some examples, the application returns results of executing the subtask. For example, an application may execute a subtask for generating a user profile, and the response from the application may include a confirmation receipt that the application generated the profile and information associated with the profile such as a user number or hyperlink to the user profile.

The processor bot 310 stores the response to a response topic 314 associated with the multi-threaded task request from which the subtask was divided. In other examples, the processor bot 310 may store the response to a response topic 314 associated with completed subtasks, or a response topic 314 associated with the node 302.

The node 302 may poll the response topic 314 and receive responses associated with completed subtasks. The node 302 may identify from the responses whether subtasks were executed successfully. For subtasks that were not executed successfully, the node 302 may generate an additional multi-threaded task request including the unsuccessful subtasks.

### Illustrative Example of Providing Responses to a Target Node

FIG. 4 illustrates example system architecture 400 for providing response to a target node. The system architecture 400 includes multiple processor bots, such as processor bot 1 410A and processor bot 2 410B; multiple application programming interfaces, such as API 1 412A and API 2 412B; a queue 408, messaging system 416; and node 402.

Processor bot 1 410A and processor bot 2 410B pull subtasks from queue 408 and determine an application programming interface associated with an application capable of performing the subtask. The processor bot 1 provides the subtask to API 1, and the application associated with API 1 executes the subtask. The application returns a response associated with the executed subtask and the application programming interface updates the queue 408. In some examples, the application programming interface updates the queue 408 to indicate a subtask was executed. In further examples, the application programming interface may store the response in the queue 408 or provide the response directly to either the messaging system 416 or the processor bots.

Because subtasks may be provided to different application programming interfaces, the system architecture 400 allows executing subtasks sequentially, concurrently, or asynchronously from one another. This allows the system architecture 400 to make progress in performing a multi-threaded task request even when computing resources for executing some subtasks of the multi-threaded task request are unavailable (e.g. when computing resources are unavailable because it is in use).

The messaging system 416 may periodically poll the queue 408 to determine whether a response was stored in the queue, or the processor bots may provide the response stored in the queue 408 to the messaging system 416. Node 402 may periodically poll the messaging system 416 to determine whether the messaging system received a response and may analyze the response to determine whether subtasks of a multi-threaded task request were successfully executed.

### Illustrative Example of Loading a Queue of Subtasks

FIG. 5 illustrates example system architecture 500 for loading a queue of subtasks. The system architecture 500 includes a node 502, multiple nodes such as topic 1 504A and topic 2 504B, messaging system 508, loader bot 510, and queue 516.

Node 502 may be a user device, such as a computer, smartphone, or laptop. In further examples, node 502 may be a computing resource such as a virtual machine or cloud service for executing computer applications.

Node 502 generates multi-threaded task requests from user selections of tasks or instructions from another node. The node 502 provides the multi-threaded task request to a topic of messaging system 508, such as topic 1 504A or topic 2 504B. Topics may be a folder or other data structure for storing the multi-threaded task request. In some examples, topics may be folders associated with the node 502 or the multi-threaded task request. For example, node 502 may store multi-threaded task requests for executing mortgage loans in topic 1 504A and multi-threaded task requests for opening a savings account in topic 2 504B.

The loader bot 510 polls the topic 1 504A and topic 2 504B of messaging system 508 to determine whether the messaging system 508 received a multi-threaded task request. When a multi-threaded task request is present, loader bot 510 pulls the multi-threaded task request from a topic and divides the multi-threaded task request into subtasks. The loader bot 510 stores the individual subtasks in queue 516. In some examples, loader bot 510 may store subtasks to a queue generated for a particular type of subtask. For example, subtasks associated with verifying user identity may be stored in a first queue and subtasks associated with generating PDF documents may be stored in a second queue.

### Example Advantages of Asynchronous Multi-Threaded Robotic Process Automation

Systems and methods for asynchronous multi-threaded robotic process automation are useful for enterprises by freeing local computing resources of a user device from being used for robotic process automation while maintaining up to date information to cloud resources performing the robotic process automation. By generating multi-threaded task requests able to be executed by cloud services (e.g., applications executed on cloud service provider infrastructure) or at a separate node, users may maintain access to their own local computing resources on their user device without ceding the local computing resources to bots performing subtasks. Further, by using a messaging system that periodically polls the user device or uses a publish-subscribe messaging model, the user device may provide up to date information to the robotic process automation module.

The use of multi-threaded task requests comprising individual tasks (e.g., subtasks) allows systems to make progress in executing the multi-threaded task request even when computing resources are unavailable or unable to execute a part of the multi-threaded task request. Because the system may execute subtasks concurrently and asynchronously, the system is not bottlenecked by subtasks that take longer or fail to execute in order to perform other subtasks of the multi-threaded task request. Further because subtasks are performed by applications executed using cloud service resources, users may use their local user device to multi-task. For example, if a subtask uses an application on a user's local computer, by implementing the above-described system, users may operate the locally executed application while the robotic process automation module uses cloud service resources perform other subtasks. The above-described system is scalable, allowing users to perform thousands and hundreds of thousands of subtasks concurrently or asynchronously.

### GENERAL CONSIDERATIONS

Although the subject matter has been described in language specific to structural features or methodological acts, it is to be understood that the subject matter of the appended claims is not necessarily limited to the specific features or acts described above. Rather, the specific features and acts described above are disclosed as examples.

Various operations of examples are provided herein. The order in which one or more or all of the operations are described should not be construed as to imply that these operations are necessarily order dependent. Alternative ordering will be appreciated based on this description. Further, not all operations may necessarily be present in each example provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has,” “with,” or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, or an ordering. Rather, such terms are merely used as identifiers, names, for features, elements, or items. For example, a first state and a second state generally correspond to state 1 and state 2 or two different or two identical states or the same state. Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the drawings. The disclosure includes all such modifications and alterations and is limited only by the scope of the following claims.

What is claimed is:

1. A method of asynchronous multi-threading comprising:
receiving a multi-threaded task request from a messaging application;
dividing the multi-threaded task request into a plurality of subtasks based on metadata associated with the multi-threaded task requests;
generating a queue comprising one or more subtasks from the plurality of subtasks;
identifying an application programming interface associated with the one or more subtasks from the queue;
routing the one or more subtasks to the application programming interface;
receiving a response from the application programming interface associated with executing the one or more subtasks; and
providing the response to the messaging application.

2. The method of claim 1, further comprising:
converting the multi-threaded task request into a text format.

3. The method of claim 1, further comprising:
polling the messaging application for an additional multi-threaded task request.

4. The method of claim 1, wherein the plurality of subtasks include one or more of: gathering user data, editing forms with the user data, generating a document, verifying identity of a user, creating user data, generating a profile based on the user data, updating user data, and deleting user data.

5. The method of claim 1, wherein the response includes information associated with an error in execution of one or more subtasks.

6. The method of claim 1, further comprising:
receiving a request from the messaging application to execute a failed subtask.

7. A system comprising:
one or more processors configured to:
receive a multi-threaded task request from a messaging application;
divide the multi-threaded task request into a plurality of subtasks based on metadata associated with the multi-threaded task requests;
generate a queue comprising one or more subtasks from the plurality of subtasks;
identify an application programming interface associated with the one or more subtasks from the queue;
route the one or more subtasks to the application programming interface;
receive a response from the application programming interface associated with executing the one or more subtasks; and
provide the response to the messaging application.

8. The system of claim 7 wherein the one or more processors are further configured to:
convert the multi-threaded task request to a text format.

9. The system of claim 7, wherein the one or more processors are further configured to:
poll the messaging application for an additional multi-threaded task request.

10. The system of claim 7, wherein the plurality of subtasks include one or more of: gathering user data, editing forms with the user data, generating a document, verifying identity of a user, creating user data, generating a profile based on the user data, updating user data, and deleting user data.

11. The system of claim 7, wherein the response includes information associated with an error in execution of one or more subtasks.

12. The system of claim 7, wherein the one or more processors are further configured to:
receive a request from the messaging application to execute a failed subtask.

13. The system of claim 7, wherein the one or more processors receive the multi-threaded task request from the messaging application using one or more of: a publish-subscribe model of communication or by streaming.

14. A non-transitory computer readable medium comprising instructions that when executed by one or more processors cause the one or more processors to:
receive a multi-threaded task request from a messaging application;
divide the multi-threaded task request into a plurality of subtasks based on metadata associated with the multi-threaded task requests;
generate a queue comprising one or more subtasks from the plurality of subtasks;
identify an application programming interface associated with the one or more subtasks from the queue;
route the one or more subtasks to the application programming interface;
receive a response associated with executing the one or more subtasks from the application programming interface; and
provide the response to the messaging application.

15. The non-transitory computer readable medium of claim 14, comprising further instructions that when executed by one or more processors cause the one or more processors to:
convert the multi-threaded task request into a text format.

16. The non-transitory computer readable medium of claim 14 comprising further instructions that when executed by one or more processors cause the one or more processors to:
poll the messaging application for an additional multi-threaded task request.

17. The non-transitory computer readable medium of claim 14, wherein the plurality of subtasks include one or more of: gathering user data, editing forms with the user data, generating a document, verifying identity of a user, creating user data, generating a profile based on the user data, updating user data, and deleting user data.

18. The non-transitory computer readable medium of claim 14, wherein the response includes information associated with an error in execution of one or more subtasks.

19. The non-transitory computer readable medium of claim 14 comprising further instructions that when executed by one or more processors cause the one or more processors to:
receive a request from the messaging application to execute a failed subtask.

20. The non-transitory computer readable medium of claim 14, wherein the multi-threaded task request from the messaging application is received using one or more of: a publish-subscribe model of communication or by streaming.
